(19) United States
(12) Patent Application Publication
(10) Pub. No.: US 2006/0224272 A1
(43) Pub. Date: Oct. 5, 2006

(54) Method for managing the storage of semiconductor material

(76) Inventors: Bo Li, Hillsboro, OR (US); Johnny Hsiang Wu, Portland, OR (US); Aishwarya Varadhan, Hillsboro, OR (US); Ron Elfacy, Modi'in (IL); Robin L. Hoskinson, Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/096,620

(22) Filed: Mar. 31, 2005

(51) Int. Cl. G06F 7/00

(52) U.S. Cl. 700/214

(57) ABSTRACT

According to one aspect of the invention, a method for managing the storage of semiconductor material is provided. The method may include processing a plurality of semiconductor substrates with a first type of semiconductor substrate processing tool to create a plurality of a first type of semiconductor substrate, determining the contents of a plurality of storage devices, each storage device being connected to a second type of semiconductor substrate processing tool, and selecting a maximum number of the first type of semiconductor substrate to be stored in each storage device, the maximum number being less than a storage capacity of the respective storage device.

### BACKGROUND OF THE INVENTION

1). Field of the Inventions

Embodiments of this invention relate to a method for managing the storage of semiconductor material.

2). Discussion of Related Art

Integrated circuits, and other semiconductor devices, are formed on semiconductor substrates, such as wafers. The formation of the devices may include numerous different processing steps, such as the formation and etching of various layers, including semiconducting, conducting, and insulating layers.

These processing steps are often performed in large fabrication factories, sometimes referred to as “fabs.” Within the fabs, Automated Material Handling Systems (AMHSs) move containers of the substrates between the different tools that are used to perform the various processing steps. A computer system is usually used to control and manage the locations of the various containers between the processing steps.

Typically, the computer systems use a static file that includes the best known storage location, more specifically the location of a larger container known as a “stocker,” for a group of substrates between particular processing steps. When a group of substrates completes a particular processing step, a storage management algorithm used by the computer system looks up the best storage location from the static file and has the AMHS perform the physical operation of storage the group of substrates at that location. The static file is not able to update its contents automatically even if the fab operation model changes.

The static file must be manually updated based on, for example, changes made to the layout of the tools and the stockers within the fab. As the layout of the tools and the fab operation changes frequently, this static file must sometimes be updated daily.

Additionally, if the selected storage destination, or stocker, is full or not available, the computer system will select the next available stocker based on another static file which entails the same difficulties stated above.

The selected storage locations are not always ideal due to the fact that similar tools which perform the same processing steps are often located in several different places in the fab. As a result, if often takes several minutes, or more, to move a particular group of substrates from one tool to the next tool for the next processing step. Thus, the tools are often “idling” as they wait for the next group of substrates to process to be delivered.

### BRIEF DESCRIPTION OF THE DRAWINGS

An embodiment of the present invention is described by way of example with reference to the accompanying drawings, wherein:

FIG. 1 is a schematic view of an Automated Material Handling System (AMHS) within a semiconductor substrate processing fab including a plurality of storage devices;

FIG. 2 is a schematic view of a computer control system for controlling the operation of the AMHS of FIG. 1;

FIG. 3 is a flow chart illustrating a method of storing semiconductor substrates within the storage devices of FIG. 3; and

FIG. 4 is a schematic view of the storage devices of FIG. 1 illustrating a prioritization of semiconductor substrates contained therein.

### DETAILED DESCRIPTION OF THE INVENTION

In the following description, various aspects of the present invention will be described, and various details set forth in order to provide a thorough understanding of the present invention. However, it will be apparent to those skilled in the art that the present invention may be practiced with only some or all of the aspects of the present invention, and the present invention may be practiced without the specific details. In other instances, well-known features are admitted or simplified in order not to obscure the present invention.

An embodiment of the present invention provides a method for managing the storage of semiconductor materials based on the progressive elimination of non-candidate storage locations. The method, or algorithm, is based on the dynamic computation of Work in Progress (WIP) inventory within a factory, or fab, and stocker loading against predefined quotas, tool cycle time calculation and comparison, and the layout of material handling system within the fab. The method may include creating a plurality of a first type of substrate with a particular tool, determining the contents of storage devices associated with “downstream” tools, and setting a “quota” for the storage of the first type of substrate within the storage devices.

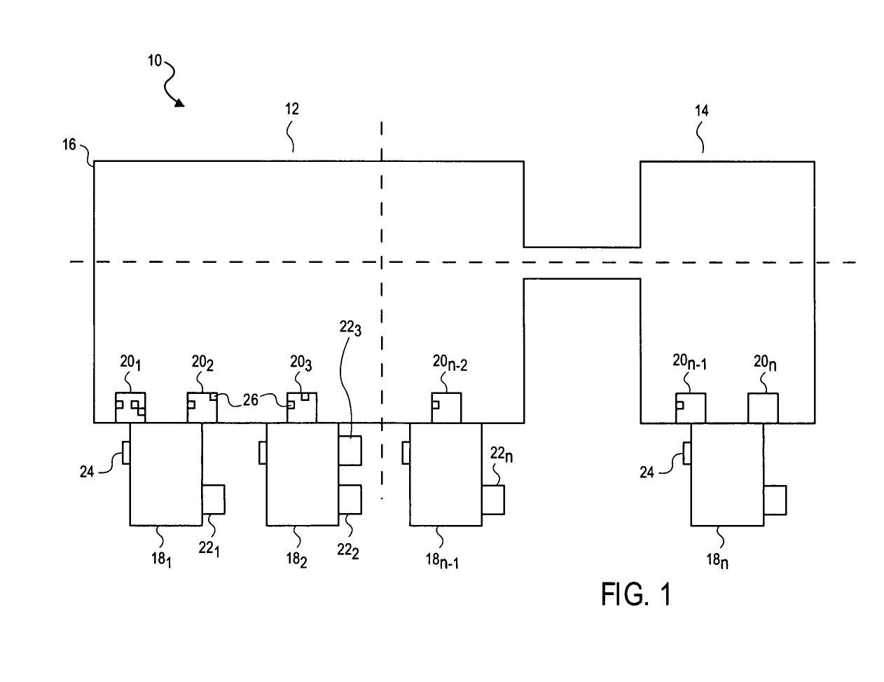

It should be understood that FIGS. 1-4 are merely illustrative and may not be drawn to scale.

FIG. 1 illustrates a semiconductor material processing fab and/or an Automated Material Handling System (AMHS) 10. The AMHS 10 may include a first building 12, a second building 14, a railway 16, and a plurality of bays 18. The railway 16 may run between the first and second buildings 12 and 14. It may include a plurality of stockers 20, or storage devices, movably connected thereto. As is commonly understood in the art, the stockers 20 may be storage machines, or devices, which can store, for example, between 100 and 200 “carriers.” The stockers 20 are capable of moving along the railway 16 between the various bays 18 in both the first 12 and second 14 buildings.

The bays 18 may be arranged in the buildings 12 and 14 in close proximity to the railway 16. The bays 18 may include a plurality of semiconductor processing tools 22 and an overhead track 24. As is commonly understood in the art, each of the tools 22 may have the ability to perform a particular step in the formation of a semiconductor device, such as an integrated circuit, including the formation and etching of various layers. Within each bay 18 the overhead track 24 may be able to move between the tools 21 and the stockers 20. Each tool 22 may be understood to be connected to, or associated with, the stockers 20 that are located at the bay 18 in which the respective tool 22 is located.

The AMHS 10 may also include numerous carriers 26. The carriers 26 may be boxes or containers that may hold up to 25 semiconductor substrates, or wafers, also known as one lot. The carriers 26 may be sized and shaped to be transported between the various bays 18 by the stockers 20 along the railway 16 in between the stockers and the tools 22 via the overhead track 24.

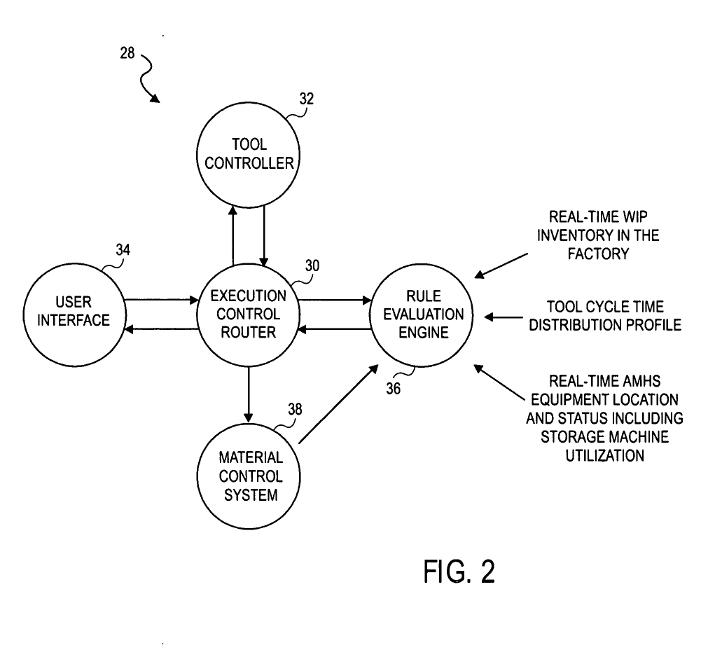

FIG. 2 illustrates a computer control system 28 for controlling the operation of the AMHS 10 illustrated in FIG. 1. The computer control system 28 may include an execution control router 30, a tool controller 32, a user interface 34, a rule evaluation engine 36, and a material control system 38. The computer control system 28 may be in the form of a computer having memory for storing a set of instructions and a processor connected to the memory for executing the instructions, as is commonly understood in the art. The computer control system 28 may be electrically connected to all of the components within the fab and/or AMHS 10.

The instructions stored within the memory may include a method including processing a plurality of semiconductor substrates with a first type of semiconductor substrate processing tool to create a plurality of a first type of semiconductor substrate, determining the contents of a plurality of storage devices, each storage device being associated with, connected to, or in close proximity with a second type of semiconductor substrate processing tool, and selecting a maximum number of the first type of semiconductor substrate to be stored in each storage device, the maximum number being less than a storage capacity of the respective storage device.

In use, a plurality, such as a lot, of semiconductor substrates may be processed with a first semiconductor substrate processing tool to create a plurality of a first type of semiconductor substrate. That is, the “type” of the substrate may refer to the processing step that has been most recently completed on the substrate. After the lot completes a process on the particular tool, the tool controller 32 may automatically communicate with the execution control router 30 to request a storage recommendation. A user may also manually request a storage recommendation from the user interface 34.

The execution control router 30 may then route the request to the rule evaluation engine 36 to determine the recommended storage location. The rule evaluation engine 36 may utilize a variety of different static and dynamic sources to search for the optimum storage location. The rule evaluation engine 36 may contain a flexible, easily modifiable, rule-based algorithm to calculate an appropriate storage location for every carrier, or lot, in the fab.

The rule evaluation engine 36 may determine the optimum storage location by taking into account, among other things, real-time AMHS equipment location and status including storage machine utilization, real-time lot inventory and stocker loading in the fab, and tool cycle time distribution profile and tool bay locations in the fab.

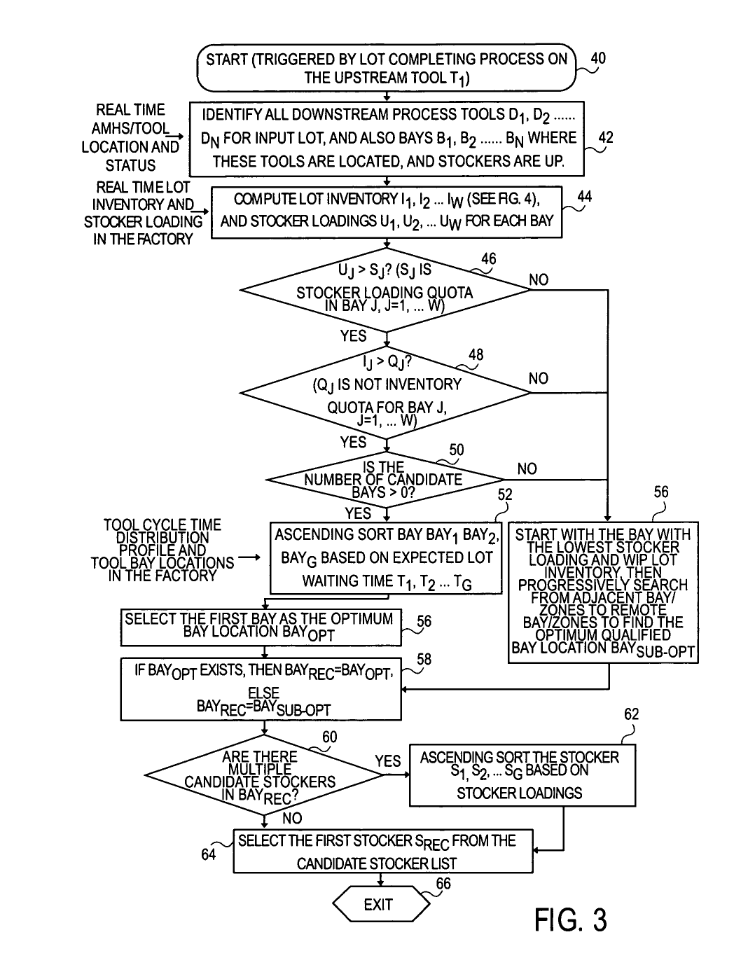

FIG. 3 illustrates the storage recommendation algorithm in greater detail. As shown in step 40 in FIG. 3, and described above, the algorithm may be started by the completion of a lot of semiconductor substrates on the first, or an “upstream,” tool in the fab 10. At step 42, the algorithm may take into account real-time AMHS and tool location, as well as status, by identifying all “downstream,” or second, process tools for the present lot and bays where these tools are located. As will be appreciated by one skilled in the art, upstream tools process substrates first, before downstream tools. It may also be determined whether or not the stockers at those particular bays are available. At step 44, real-time lot inventory and stocker loading in the fab may be accounted for by computing lot inventory and stocker loadings for each bay. That is, the contents of each storage device 22 that is associated with, or connected to, bays 18 that include tools 22 that are able to complete the next processing step on the substrates may be determined.

A quota, or maximum number, of each type of substrate to be stored in each storage device may be set. These maximum numbers may be less than a storage capacity of the storage devices, and the sum of the maximum numbers of the various types of substrates for each storage device may also be less than the storage capacity of the storage devices. Thus, the storage devices are never overloaded.

At step 46, the determination may be made whether or not the stocker loading for each bay exceeds the stocker loading quota for each bay. If the stocker loading for each bay is greater than the stock of loading quota, at step 48 it may be determined whether or not the lot inventory for each bay is greater than the lot inventory quota for each bay. At step 50, it may be determined if the number of candidate bays is above zero.

Thus, candidate storage devices may be selected by determining which of the downstream storage devices have a total number of the particular type of semiconductor substrate that does not exceed the set maximum number for the selected type of semiconductor substrate.

Still referring to FIG. 3, at step 52, the tool cycle time distribution profile and tool bay locations in the fab may be accounted for and a list of candidate bays is generated and listed in ascending order based on expected lot waiting time. Tool cycle time may be understood to be the average elapsed time between when the lot enters a particular tool and when the lot leaves the particular tool. Lot waiting time may be understood to be the average elapsed time to wait for high priority lot inventory to complete processing within the particular bay. That is, lot waiting time may be the time it will take to process the other substrates within the stocker before the selected type, or lot, will be processed.

At step 54, the first bay in the list generated in step 52 may be selected as the optimum storage location. Thus, the optimum storage location, device, or bay, may be chosen as the candidate storage location with the shortest waiting time. It may be possible to chose more than one optimum storage location if the expected lot waiting time is the same for two storage devices. If there are multiple optimum storage locations, the location that is in the closest proximity to the second process tool is selected.

If the answer to any of steps 46, 48, or 50 is “no,” the algorithm may proceed to step 56. At step 56, a suboptimum storage location may be determined by starting with the bay with lowest stocker loading and WIP lot inventory, then progressively searching from adjacent bays and zones to remote bays and zones.

At step 58, it may be determined whether or not an optimum bay is available, if so it is chosen as the bay to receive the present lot. Otherwise a different, suboptimum bay may be chosen. At step 60, it may be determined whether or not there are multiple candidate stockers in the chosen bay. At step 62, if there are multiple candidate stockers within the optimum bay, the stockers may be sorted in ascending order based on stocker loadings. At step 64, the first stocker from the candidate stocker list may chosen, and at step 66 the algorithm may end. Thus, the stocker in the optimum bay with the lowest stocker inventory may be chosen to store the lot.

Referring again to FIG. 2, the rule evaluation engine 36 may then respond to the execution control router 30 with a list of lots and recommended storage locations. The execution control router may then send a transaction success notification to the tool controller 32 or the user interface 34. The execution control router may also route the particular carrier for a specified lot and storage destination information to the material control system 38 to initiate the physical delivery of the specified lots.

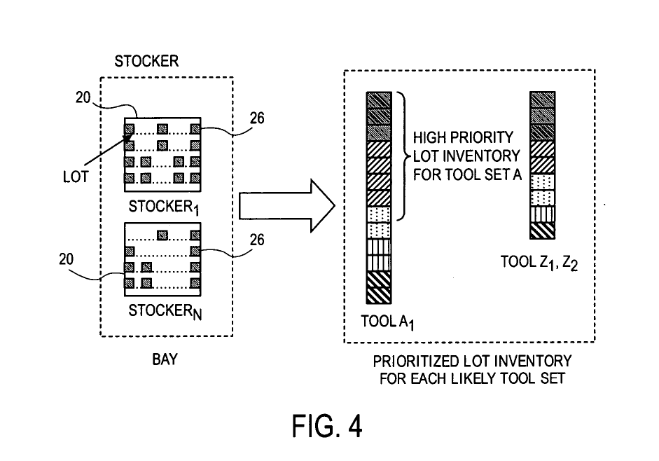

FIG. 4 illustrates the prioritization substrates of the lots, carriers 26, within the stockers 20. As shown in FIG. 4, each lot may be assigned a priority based on an assigned importance. The high priority lots for a particular tool set may be processed before the lower priority lots. As discussed above, the prioritization of the lots may be accounted for in determining lot waiting time.

One advantage is that because the system utilizes real-time data from the storage devices, it is possible to more accurately determine WIP storage locations. Therefore, overloading stockers and bays with the same type of substrates is avoided. At the same time, time required to transport substrates between tools is reduced, the idling of the tools is minimized, and the number of substrates that can be processed by the fab is increased. Another advantage is that because storage quotas categorized by process are established, the effective selection of the optimum storage location is more likely. A further advantage is that because the system uses real-time data of the WIP inventory within the fab, there is little or no need to alter the AMHS when the layout of the fab is changed or the fab operation model is altered.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method for managing the storage of semiconductor substrates comprising:
processing a plurality of semiconductor substrates with a first type of semiconductor substrate processing tool to create a plurality of a first type of semiconductor substrate;
determining the contents of a plurality of storage devices, each storage device being connected to a second type of semiconductor substrate processing tool; and
selecting a maximum number of the first type of semiconductor substrate to be stored in each storage device, the maximum number being less than a storage capacity of the respective storage device.

2. The method of claim 1, further comprising:
selecting a plurality of candidate storage devices from the plurality of storage devices, each candidate storage device containing a total number of the first type of semiconductor substrate that is less than the maximum number for the respective storage device.

3. The method of claim 2, further comprising:
calculating a waiting period associated with each candidate storage device, the waiting period being the amount of time before the first type of semiconductor substrate will be processed by the second type of semiconductor processing tool connected to the respective candidate storage device.

4. The method of claim 3, further comprising:
selecting at least one optimum storage device, the at least one optimum storage device being associated with a shortest of the waiting periods.

5. The method of claim 4, further comprising:
storing the plurality of first type of semiconductor substrates in a selected one of the at least one optimum storage devices, the selected one of the at least one optimum storage devices having the least contents of the at least one storage devices.

6. The method of claim 2, further comprising:
storing the plurality of the first type of semiconductor substrate in a closest proximity storage device, the closest proximity storage device being one of the candidate storage devices that is located closest to the second type of semiconductor substrate processing tool.

7. The method of claim 5, wherein the storage devices are stockers within a semiconductor substrate processing factory, the semiconductor substrate processing tools are located within bays in the factory, and each storage device is connected to the semiconductor substrate processing tools located within each respective bay.

8. An article of manufacture including program code which, when executed by a machine, causes the machine to perform a method, the method comprising:
processing a plurality of semiconductor substrates with a first type of semiconductor substrate processing tool to create a plurality of a first type of semiconductor substrate;
determining the contents of a plurality of storage devices, each storage device being connected to a second type of semiconductor substrate processing tool; and
selecting a maximum number of the first type of semiconductor substrate to be stored in each storage device, the maximum number being less than a storage capacity of the respective storage device.

9. The article of manufacture of claim 8, wherein the method further comprises selecting a plurality of candidate storage devices from the plurality of storage devices, each candidate storage device containing a total number of the first type of semiconductor substrate that is less than the maximum number for the respective storage device.

10. The article of manufacture of claim 9, wherein the method further comprises calculating a waiting period associated with each candidate storage device, the waiting period being the amount of time before the first type of semiconductor substrate will be processed by the second type of semiconductor processing tool connected to the respective candidate storage device.

11. The article of manufacture of claim 10, wherein the method further comprises selecting at least one optimum storage device, the at least one optimum storage device being associated with a shortest of the waiting periods.

12. The article of manufacture of claim 11, wherein the method further comprises storing the plurality of first type of semiconductor substrates in a selected one of the at least one optimum storage devices, the selected one of the at least one optimum storage devices having the least contents of the at least one storage devices.

13. The article of manufacture of claim 9, wherein the method further comprises storing the plurality of the first type of semiconductor substrate in a closest proximity storage device, the closest proximity storage device being one of the candidate storage devices that is located closest to the second type of semiconductor substrate processing tool.

14. The article of manufacture of claim 12, wherein the storage devices are stockers within a semiconductor substrate processing factory, the semiconductor substrate processing tools are located within bays in the factory, and each storage device is connected to the semiconductor substrate processing tools located within each respective bay.

15. A computing system comprising instructions disposed on a computer readable medium, said instructions capable of being executed by said computing system to perform a method, said method comprising:
processing a plurality of semiconductor substrates with a first type of semiconductor substrate processing tool to create a plurality of a first type of semiconductor substrate;
determining the contents of a plurality of storage devices, each storage device being connected to a second type of semiconductor substrate processing tool; and
selecting a maximum number of the first type of semiconductor substrate to be stored in each storage device, the maximum number being less than a storage capacity of the respective storage device.

16. The computer system of claim 15, wherein the method further comprises selecting a plurality of candidate storage devices from the plurality of storage devices, each candidate storage device containing a total number of the first type of semiconductor substrate that is less than the maximum number for the respective storage device.

17. The computer system of claim 16, wherein the method further comprises calculating a waiting period associated with each candidate storage device, the waiting period being the amount of time before the first type of semiconductor substrate will be processed by the second type of semiconductor substrate processing tool connected to the respective candidate storage device.

18. The computer system of claim 17, wherein the method further comprises selecting at least one optimum storage device, the at least one optimum storage device being associated with a shortest of the waiting periods.

19. The computer system of claim 18, wherein the method further comprises storing the plurality of first type of semiconductor substrates in a selected one of the at least one optimum storage devices, the selected one of the at least one optimum storage devices having the least contents of the at least one storage devices.

20. The computer system of claim 16, wherein the method further comprises storing the plurality of the first type of semiconductor substrate in a closest proximity storage device, the closest proximity storage device being one of the candidate storage devices that is located closest to the second type of semiconductor substrate processing tool.

21. The computer system of claim 19, wherein the storage devices are stockers within a semiconductor substrate processing factory, the semiconductor substrate processing tools are located within bays in the factory, and each storage device is connected to the semiconductor substrate processing tools located within each respective bay.
